(19) United States
(12) Patent Application Publication
(10) Pub. No.: US 2024/0044633 A1
(43) Pub. Date: Feb. 8, 2024

(54) Personal vehicle alignment tool

(71) Applicant: Jesse Carlisle, Muskegon, MI (US)

(72) Inventor: Jesse R. Carlisle, Muskegon, MI (US)

(21) Appl. No.: 17/818,306

(22) Filed: Aug. 8, 2022

(51) Int. Cl. G01B 5/255

(52) U.S. Cl. CPC G01B 5/255

(57) ABSTRACT

A personal alignment tool is designed to for use in a vertical or horizontal position. The tool is generally shaped like a bed frame, which includes four legs, two cross members and a main support shaft. The frame is an ergonomically designed structure that easily mounts to the outer surface of any tire, allowing an individual to mount the tool to any vehicle.

The present invention relates generally to single-person alignment tool. More specifically, the present invention includes a tool designed to be used in a vertical or horizontal position on any vehicle, including equipment, semi trucks, and overweight vehicles. Wherein the tool owner can establish a reference point, to start their alignment.

People have used many means to align and adjust steering, such as rotor mounted and automatic alignment machines. These specific tools been developed to facilitate repair on many vehicles. Domestic vehicles are compatible with automatic alignment machines. Racecars are compatible to rotor mounted alignment tools for specific angularity.

Tool Interface on existing human powered alignment tools have several features and disadvantages. Rotor mounted alignment tools are bolted to the flat surface of a brake rotor, however the tires must be removed and vehicle must be lifted from the ground. This arrangement limits their use due to improper weight distribution, while aligning the vehicle, which causes misalignment. Automatic alignment machines require a vehicle to be lifted from the ground as well; this restricts many vehicles from receiving a proper alignment. Automatic alignment machines are expensive and require maintenance.

In the realm of alignment tools, the skill needed to successfully complete repairs has limited spread of the repair due to the level of skill and equipment required. The potential for misalignment is the most often-cited deterrent for people interested in alignment tools. Having the skill to successfully “align” a vehicle creates a criterion for safety and accessibility that limits a large segment of interested people from maintaining their vehicle themselves.

### SUMMARY OF THE INVENTION

The present invention overcomes these limitations by combining simplicity and structure (further shown and described in the drawings) of the tool, and having increased stability by providing a better weight distribution. Without removing tires from a vehicle and not requiring the vehicle to be lifted from the ground. In one embodiment, the tool is powered by the operator's hands, much like mounting a tire cover. The tool is constructed so that it cradles the full body of a tire, so that the tire supports the tools structure. The present Invention overcomes the problem mis-alignment. This vehicle on the ground is much more stable and makes the tool more capable to do the proper alignment.

Furthermore, this tool gives an individual the comfort and satisfaction of knowing their vehicle is free from defect. Lastly, the tool is not restricted to use on various vehicles and actually expands the capability for use on “other vehicles” that cannot be aligned by the current inventory of alignment tools. Such “other vehicles” are semi, backhoe, and trucks with height or weight restrictions. These “other vehicles” are limited from alignment due to size or

### BRIEF DESCRIPTION OF THE DRAWINGS

These and other features, aspects, and advantages of the present invention will become better understood with regards to the following description, appended claims, and accompanying drawings where:

FIG. 1 is a perspective view of one embodiment of a personal alignment tool designed to attach to a tire of any vehicle.

FIG. 2 is a side view of one embodiment of a sliding cross member designed to attach to a tire of any vehicle.

FIG. 3 is a side view of one embodiment of a fixed cross member designed to attach to a tire of any vehicle.

FIG. 4 is a front view of one embodiment of a sliding cross member designed to attach to a tire of any vehicle.

FIG. 5 is a front view of one embodiment of a fixed cross member designed to attach to a tire of any vehicle.

FIG. 6 is a perspective view of another embodiment of an alignment tool in use, further showing the tool applied to a tire in its perspective position.

### DETAILED DESCRIPTION OF THE INVENTION

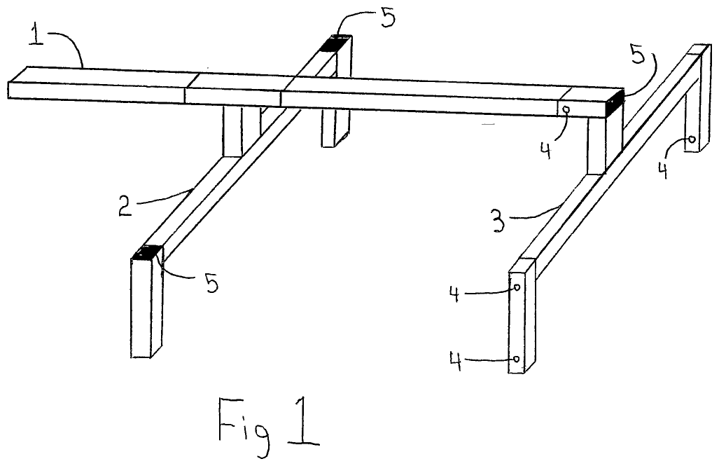

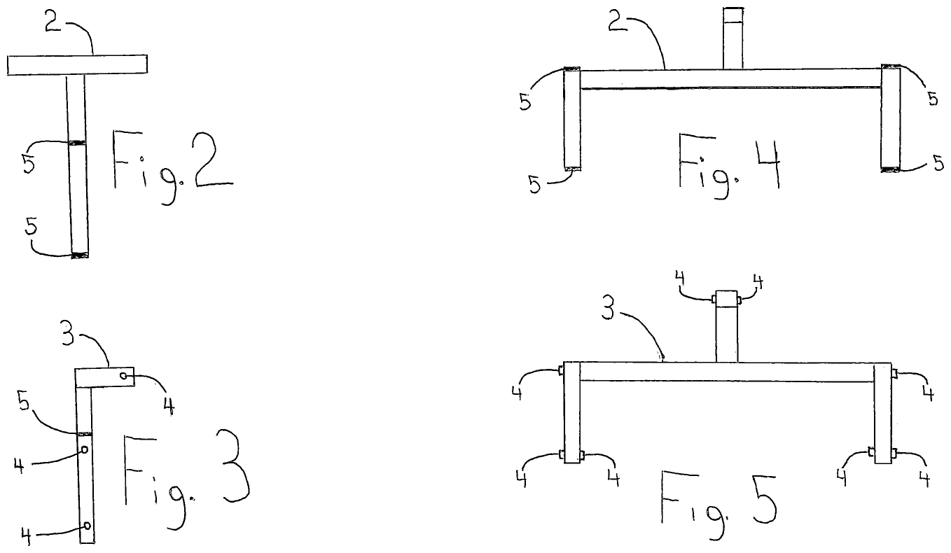

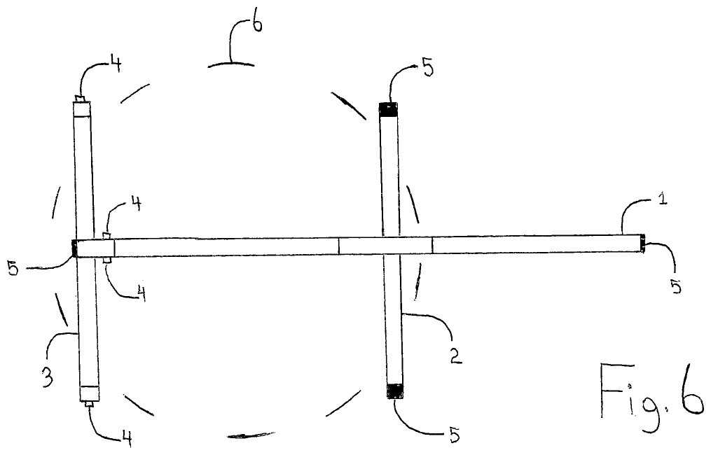

The present invention includes an alignment tool that is designed to place on a tire of any vehicle as shown in FIGS. 1-6. The tool is generally shaped like a bed frame, including a sliding crossmember FIG. 2 and a fixed cross member FIG. 3, and includes a main support shaft 1. The main support shaft 1 allows the individual to comfortably position the tool in a place that suits them. In a preferred embodiment, the lateral sides FIG. 2 and FIG. 3 of the tool are extended to further support the tool in its position, as shown in FIGS. 1,2, and 3. The lateral sides are designed to be long enough to reach the tire treads for a flat mating surface. It is further contemplated that the recessed area may be customized for any particular tire size.

In one embodiment, the tool includes a recessed area to accommodate for the tire, as shown in FIG. 4. The tool contains a main support shaft 1, in one embodiment, is completely straight and free from torque. The main support shaft 1 is intended to be parallel with the outer plain of a tire 6. The tool can be any practical or suitable length and width. The primary function of the tool design is to cradle a tire's sidewall, to allow for a superior mounting surface.

The tool may be manufactured using any suitable process. One such method includes the steps of welding steel tubing shaped like a bed frame. The frame is designed to conform to each tire size with no restrictions to height or width. The embodiment in FIG. 4 also includes the sliding cross member FIG. 2 is sealed with plastic caps 5. The plastic caps 5 are designed for a smooth surface to eliminate any safety hazards. The embodiment in FIG. 4, also includes the fixed cross member 3 has open legs with cap bolts 4. The cap bolts 4, are designed for anchor points as the individual can choose to secure the alignment tool if needed.

As mentioned heretofore, it should be understood that the tool may be used on any kind of tire, off road, on road, semi, and race tire. Further, although the tool is designed to use in a vertical or horizontal position, it should be understood that the tool could be used in other position's that maybe better suited for the individual.

Although the present invention has been described in considerable detail with reference to certain preferred versions thereof, other versions are possible. Therefore, the spirit and scope of the appended claims should not be limited to the description of the preferred versions contained herein. All features disclosed in this specification may be replaced by alternative features serving the same, equivalent or similar purpose, unless expressly stated otherwise. Thus, unless expressly stated otherwise, each feature disclosed is one example only of a generic series of equivalent or similar features.

What I claim is:

1. A personal alignment tool comprising:
A metal sliding frame that can be secured or remain at rest in a vertical or horizontal position on the outer surface of a tire thereof;
Wherein said frame further includes a straight main support shaft extending laterally from one lateral side of the said frame to an opposing lateral side of the said frame;
A recessed cavity on an lower side of said tool, said recessed cavity being adapted to receive the body of a tire in operable position, wherein said recessed cavity includes four elevated lateral sides, and wherein said recessed cavity an area to accommodate all various tire sizes;
Whereby a individual may hold said personal alignment tool in any position so that said tire may be completely contained within said recessed cavity allows tire to measured and secured for proper inspection.

2. The personal alignment tool set forth in claim 1, wherein said area to main support shaft once secured should accommodate an individual's ability to utilize tool to check its securement; A securement check on said tool, said securement check may adhere to the functionality of said tool, wherein securement check includes variations of finding loose securements located in or on vehicle, and wherein said securement check, loose securements require further inspections.
